(19) United States
(12) Patent Application Publication
(10) Pub. No.: US 2017/0054640 A1
(43) Pub. Date: Feb. 23, 2017

(54) DEVICE AND METHOD FOR ESTABLISHING CONNECTION IN LOAD-BALANCING SYSTEM

(71) Applicant: ALIBABA GROUP HOLDING LIMITED, George Town (KY)

(72) Inventors: Bengbeng XUE, Hangzhou (CN); Jiaming WU, Hangzhou (CN); Yi LI, Hangzhou (CN)

(73) Assignee: ALIBABA GROUP HOLDING LIMITED

(21) Appl. No.: 15/242,419

(22) Filed: Aug. 19, 2016

(30) Foreign Application Priority Data
Aug. 20, 2015 (CN) 201510516359.9

(51) Int. Cl. H04L 12/803; H04L 5/00; H04L 29/08

(52) U.S. Cl. CPC H04L 47/125; H04L 67/146; H04L 67/2814; H04L 5/0055

(57) ABSTRACT

An apparatus for establishing a connection in a load-balancing system is provided. The apparatus is coupled between a client device and a real server that provides services to the client device. The apparatus includes: a memory device storing instructions; and a processor configured to execute the instructions stored in the memory device to: receive a synchronous (SYN) packet from the client device, the SYN packet including client connection information; based on the client connection information, compute a serial number; return a first synchronous acknowledgement (SYN+ACK) packet to the client device, the first SYN+ACK packet including connection information of the real server; receive an acknowledgement (ACK) packet from the client; generate a self-defined packet to include the client connection information; and forward the self-defined packet to the real server

### CROSS-REFERENCE TO RELATED APPLICATIONS

This application is based upon and claims priority to Chinese Patent Application No. 201510516359.9, filed Aug. 20, 2015, the entire contents of which are incorporated herein by reference.

### TECHNICAL FIELD

The present disclosure generally relates to the field of communication technology, and more particularly, to a device and method for establishing connection in a load-balancing system.

### BACKGROUND

Balancing the loads of servers is a technique in which a load-balancing device re-directs flows of client visits to several back-end servers to evenly distribute the visits to the back-end servers.

Because a load-balancing system includes a load-balancing device, service-request packets from the client devices (clients) need to be re-directed by the load-balancing device to the back-end servers (e.g., real servers) that handles the service-request packets. This changes the processing flow of the packets. In a related load-balancing system, a processing flow of the packets includes the forwarding of request packets by a client to a load-balancing device, which then forwards the client request packet to a real server. The real server then forwards a response packet directly to the client.

Before forwarding the client request packet, a connection based on Transmission Control Protocol (TCP) between the client and the real server needs to be established. In the related art, to establish a TCP connection, a three-way handshake needs to be performed according to the TCP. Establishing a TCP connection in the above load-balancing system includes the following steps:

The client forwards a synchronous (SYN) packet to the load-balancing device. An option field of the SYN packet includes the client connection information.

The load-balancing device forwards the SYN packet to the real server. The real server creates a database to store the client connection information and establishes a half-open connection with the client.

The real server returns a synchronous acknowledgement (SYN+ACK) packet to the client. The SYN+ACK packet includes connection information of the real server.

The client forwards an acknowledgement (ACK) packet to load-balancing device.

The load-balancing device forwards the ACK packet to the real server.

When the real server receives the ACK packet, it converts the half-open TCP connection to full TCP connection with the client.

However, an attacker may use the protocol flaws to attack the TCP connection while the TCP connection is being established. If the attacker sends a lot of SYN packets to the real server, the server would need to create a very large database and diverts a lot of system resources to establish half-open TCP connections, resulting in legitimate requests not being handled, which affects the normal services provided by the real server.

### SUMMARY

It is to be understood that both the foregoing general description and the following detailed description are exemplary and explanatory only and are not restrictive of the invention, as claimed. <INSERT>

Consistent with embodiments of the present disclosure, there is provided an apparatus for establishing a connection in a load-balancing system. The apparatus is coupled between a client device and a real server that provides services to the client device. The apparatus includes: a memory device storing instructions; and a processor configured to execute the instructions stored in the memory device to: receive a synchronous (SYN) packet from the client device, the SYN packet including client connection information; based on the client connection information, compute a serial number; return a first synchronous acknowledgement (SYN+ACK) packet to the client device, the serial number being assigned to be a serial number of the first SYN+ACK packet, the first SYN+ACK packet including connection information of the real server; receive an acknowledgement (ACK) packet from the client and compute to obtain the client connection information based on a confirmation number of the ACK packet; generate a self-defined packet to include the client connection information; and forward the self-defined packet to the real server so that the real server extracts the client connection information from the self-defined packet and establishes a Transmission Control Protocol (TCP) connection with the client device based on the client connection information.

Consistent with embodiments of the present disclosure, there is provided a non-transitory computer readable medium that stores a set of instructions that is executable by at least one processor of a device to cause the device to perform a method. The method includes: receiving a synchronous (SYN) packet from the client device, the SYN packet including client connection information; based on the client connection information, computing a serial number; returning a first synchronous acknowledgement (SYN+ACK) packet to the client device, the serial number being assigned to be a serial number of the first SYN+ACK packet, the first SYN+ACK packet including connection information of the real server; receiving an acknowledgement (ACK) packet from the client and computing to obtain the client connection information based on a confirmation number of the ACK packet; generating a self-defined packet to include the client connection information; and forwarding the self-defined packet to the real server so that the real server extracts the client connection information from the self-defined packet and establishes a Transmission Control Protocol (TCP) connection with the client device based on the client connection information.

Consistent with embodiments of the present disclosure, there is provided a method for establishing a connection in a load-balancing system. The method is performed by a load-balancing device coupled between a client device and a real server that provides services to the client device. The method includes: receiving a synchronous (SYN) packet from the client device, the SYN packet including client connection information; based on the client connection information, computing a serial number; returning a first synchronous acknowledgement (SYN+ACK) packet to the client device, the serial number being assigned to be a serial number of the first SYN+ACK packet, the first SYN+ACK packet including connection information of the real server; receiving an acknowledgement (ACK) packet from the client and computing to obtain the client connection information based on a confirmation number of the ACK packet; generating a self-defined packet to include the client connection information; and forwarding the self-defined packet to the real server so that the real server extracts the client connection information from the self-defined packet and establishes a Transmission Control Protocol (TCP) connection with the client device based on the client connection information.

Consistent with embodiments of the present disclosure, there is provided a method for establishing a connection in a load-balancing system. The method is performed by a client device coupled to a load-balancing device and a real server that provides services to the client device. The method includes: forwarding a synchronous (SYN) packet to the load-balancing device, the SYN packet including client connection information; receiving a synchronous acknowledgement (SYN+ACK) packet returned from the load-balancing device, wherein a serial number of the SYN+ACK packet is obtained by the load-balancing device performing computation based on the client connection information included in the SYN packet, the SYN+ACK packet including connection information of the real server; and forwarding an acknowledgement (ACK) packet to the load-balancing device so that the load-balancing device performs computation to obtain the client connection information based on a confirmation number of the ACK packet, generates a self-defined packet to include the client connection information, and forwards the self-defined packet to the real server such that the real server extracts the client connection information from the self-defined packet and establishes a Transmission Control Protocol connection with the client device based on the client connection information.

Consistent with embodiments of the present disclosure, there is provided a method for establishing a connection in a load-balancing system. The method is performed by a real server coupled to a load-balancing device and a client device. The real server is configured to provide services to the client device. The method includes: receiving a self-defined packet transmitted from the load-balancing device, wherein the self-defined packet is generated by a process in which the load-balancing device receives a synchronous (SYN) packet transmitted from the client device, computes a serial number based on client connection information included in the SYN packet, assigns the serial number to a synchronous acknowledgement (SYN+ACK) packet that includes connection information of real server, receives an acknowledgement (ACK) packet from the client device, performs computation to obtain the client connection information based on a confirmation number of the ACK packet, and generates the self-defined packet to include the client connection information; extracting the client connection information from the self-defined packet; and establishing a Transmission Control Protocol connection with the client device based on the client connection information.

Consistent with embodiments of the present disclosure, there is provided an apparatus for establishing a connection in a load-balancing system. The apparatus is coupled between a client device and a real server that provides services to the client device. The apparatus includes: a first receiving module configured to receive a synchronous (SYN) packet from the client device, the SYN packet including client connection information; a computing module configured to, based on the client connection information, compute a serial number; a first responding module configured to return a first synchronous acknowledgement (SYN+ACK) packet to the client device, the serial number being assigned to be a serial number of the first SYN+ACK packet, the first SYN+ACK packet including connection information of the real server; a second receiving module configured to receive an acknowledgement (ACK) packet from the client and compute to obtain the client connection information based on a confirmation number of the ACK packet; a generating module configured to generate a self-defined packet to include the client connection information; and a first forwarding module configured to forward the self-defined packet to the real server so that the real server extracts the client connection information from the self-defined packet and establishes a Transmission Control Protocol (TCP) connection with the client device based on the client connection information.

Consistent with embodiments of the present disclosure, there is provided an apparatus for establishing a connection in a load-balancing system. The apparatus is coupled to a load-balancing device and a real server that provides services to the apparatus. The apparatus includes: a second forwarding module configured to forward a synchronous (SYN) packet to the load-balancing device, the SYN packet including client connection information; a third receiving module configured to receive a synchronous acknowledgement (SYN+ACK) packet returned from the load-balancing device, wherein a serial number of the SYN+ACK packet is obtained by the load-balancing device performing computation based on the client connection information included in the SYN packet, the SYN+ACK packet including connection information of the real server; and a second responding module configured to forward an acknowledgement (ACK) packet to the load-balancing device so that the load-balancing device performs computation to obtain the client connection information based on a confirmation number of the ACK packet, generates a self-defined packet to include the client connection information, and forwards the self-defined packet to the real server such that the real server extracts the client connection information from the self-defined packet and establishes a Transmission Control Protocol connection with the apparatus based on the client connection information.

Consistent with embodiments of the present disclosure, there is provided an apparatus for establishing a connection in a load-balancing system. The apparatus is coupled to a load-balancing device and a client device, the apparatus being configured to provide services to the client device. The apparatus includes: a fourth receiving module configured to receive a self-defined packet transmitted from the load-balancing device, wherein the self-defined packet is generated by a process in which the load-balancing device receives a synchronous (SYN) packet transmitted from the client device, computes a serial number based on client connection information included in the SYN packet, assigns the serial number to a synchronous acknowledgement (SYN+ACK) packet that includes connection information of the apparatus, receives an acknowledgement (ACK) packet from the client device, performs computation to obtain the client connection information based on a confirmation number of the ACK packet, and generates the self-defined packet to include the client connection information; an extracting module configured to extract the client connection information from the self-defined packet; and a connection establishment module configured to establish a Transmission Control Protocol connection with the client device based on the client connection information.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1 is a flow chart illustrating a method for establishing a connection in a load-balancing system, consistent with embodiments of the present disclosure.

FIG. 2 is a flow chart illustrating another method for establishing a connection in a load-balancing system, consistent with embodiments of the present disclosure.

FIG. 3 is a flow chart illustrating another method for establishing a connection in a load-balancing system, consistent with embodiments of the present disclosure.

FIG. 4A is block diagram illustrating an exemplary load-balancing device consistent with embodiments of present disclosure.

FIG. 4B is block diagram illustrating the forwarding module as shown in FIG. 4A, consistent with embodiments of present disclosure.

FIG. 4C is block diagram illustrating the second receiving module as shown in FIG. 4A, consistent with embodiments of present disclosure.

FIG. 5 is a block diagram of an exemplary client device of a load-balancing system, consistent with embodiments of the present disclosure.

FIG. 6 is a block diagram of an exemplary real server of a load-balancing system, consistent with embodiments of the present disclosure.

FIG. 7 is a block diagram an exemplary load-balancing system, consistent with embodiments of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims.

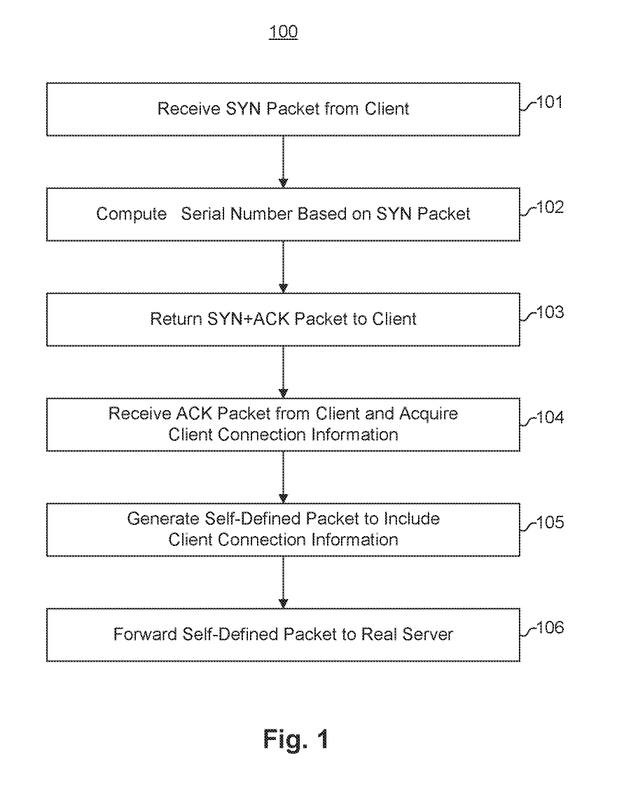

FIG. 1 is a flow chart illustrating a method 100 for establishing a connection in a load-balancing system, consistent with embodiments of the present disclosure. The method 100 may be performed by a load-balancing device in the load-balancing system. Referring to FIG. 1, the method 100 includes the following steps:

In step 101, the load-balancing device receives an SYN packet from a client. The SYN packet includes the client connection information. Consistent with embodiments of the present disclosure, the client connection information may be used to connect to the client.

In step 102, the load-balancing device computes a serial number based on the SYN packet received from the client.

In step 103, the load-balancing device returns an SYN+ACK packet to the client, and assigns the serial number to the SYN+ACK packet. In some embodiments, the SYN+ACK packet may include connection information of a real server. Consistent with embodiments of the present disclosure, the connection information of the real server may be used to connect to the real server.

In step 104, the load-balancing device receives an ACK packet from the client and, based on a confirmation number included in the ACK packet, acquires the client connection information.

In one embodiment, the confirmation number may be the serial number plus a number, such as one. The load-balancing device may perform a simple calculation of subtracting one from the confirmation number to obtain the serial number. Based on the serial number, the load-balancing device may determine the client connection information.

In step 105, the load-balancing device generates a self-defined packet to include the client connection information.

In step 106, the load-balancing device forwards the self-defined packet to the real server so that the real server may extract the client connection information from the self-defined packet and establish a TCP connection with the client.

In the illustrated embodiment, the load-balancing device uses the client connection information included in the SYN packet to compute the serial number, and assigns the serial number to the SYN+ACK packet, so that the real server does not need to create a database to store the client connection information. Because the real server does not spend resources creating a database to store the client connection information, method 100 reduces the consumption of resources and provides defense to attacks that cause the real server to create a large database, exhausting its resources.

In the illustrated embodiment, the defense to the attacks is realized by the load-balancing device, which further shields the real server from attacks. By correlating the client connection information with the serial number of the SYN+ACK packet and receiving the ACK packet from the client, the load-balancing device completes a communication process similar to the three-way handshakes of the TCP. Further, the load-balancing device transmits the connection information of the real server to the client so that the real server may establish a TCP connection with the client. This facilitates a normal TCP connection established between the client and the real server.

Because a TCP connection is established between the client and the real server, based on a load-balancing mode of the load-balancing device, the client may forward a request packet to the load-balancing device. The load-balancing device may then forward the request packet to a real server such that the real server may directly reply to the client with a responsive packet.

In some embodiments, a header of TCP packet may generally include fields of a source port, a destination port, a serial number, a confirmation number, reserved bits, TCP options, windows, check portions, urgent pointer, etc. A source port is a port or procedure that sends a packet. A destination port is a port or procedure that receives a packet.

A serial number is used to mark a packet so that the device receiving the packet may confirm the data included in the packet based on the serial number. When establishing a connection, both parties may provide an initial serial number. In the illustrated embodiment, the serial number of the SYN+ACK packet may be an initial serial number, which may be obtained by computation based on the client connection information. The client connection information may be preserved in the serial number transmitted between devices. This avoids the need to create a database to store the client connection information and reduces the use of resources.

A confirmation number may be used to confirm that one or more specific packets have been received. In the illustrated embodiment, the confirmation number may equal the serial number of the last received packet plus one.

In the illustrated embodiment, the serial number that is computed based on the client connection information may be obtained by subtracting one from the confirmation number included in the ACK packet returned from the client. Based on the serial number, the client connection information may be determined.

The connection information may be included into TCP option fields. The load-balancing device may analyze the TCP option fields of the SYN packet to acquire the client connection information. The client may analyze the TCP option fields of the SYN+ACK packet to acquire the connection information of the real server. The client connection information may be included in the TCP option fields of the self-defined packet.

The TCP option fields of the SYN+ACK packet returned from the load-balancing device includes the connection information of the real server. The connection information of the real server may be acquired by the load-balancing device through negotiation with the real server.

In the related art, an attacker may take advantage of the loophole in the TCP scheme and sends a large quantity of SYN packets to attack the real server. This is called synchronous flood (SYN flood). The attack is effectuated because once the real server receives the large quantity of SYN packets, it may be forced to use a lot of resources to create a large database to store the data included in the SYN packets. This makes the real server unavailable to attend to the normal packets and affects the services provided by the real server.

SYN flood is one of the well-known Denial of Services (DoS) attack or Distributed Denial of Service (DDoS) attack. The attack causes the attacked device to exhaust its resources. For example, because of the attack, a CPU may reach its full capacity and cannot process the normal service requests, or the internal memory of the attached device is occupied from having to store the trash information.

Because the client connection information is included in serial number of the SYN+ACK packet transmitted from the load-balancing device, it is not necessary to create a database to store the client connection information. The method consistent with embodiments of the present disclosure does not consume much resources and provides defense to SYN flood attacks in the load-balancing device. The method improves defense to the attacks and reduces consumption of resources so that normal service request may be serviced.

Consistent with embodiments of the present disclosure, in a load-balancing mode, request flows from the client to the real server go through the load-balancing device, and the response flows from the real server to the client do not go through the load-balancing device. In the response flows, the real server transmits reply packet directly to the client so as to reduce the load to the load-balancing device. Accordingly, the load-balancing device would be a bottleneck for response flows.

In some embodiments, connection information included in TCP option fields may include:

mss: maximum segment size, indicating a length of the maximum data transmitted to another terminal via a TCP connection;

wsscale: window scale option, used to increase a size of TCP receiving window to more than 65536 bytes;

timestamp: a timestamp option, employed by a sender of a packet to include a timestamp in a packet, which will be returned by a receiver after the receiver confirms the receipt so that the sender may calculate a round-trip time (RTT) for each ACK packet; and

SACK: selective acknowledgment, allowing a party to re-send only the lost packets, but not all of the subsequent packets, and providing a corresponding mechanism enabling the receiver to inform the sender of the lost data, the re-sent data, and the received data, etc.

Exemplary methods of generating a self-defined packet that includes the client connection information are explained below.

In one embodiment, the ACK packet returned from the client may be directly modified to form the self-defined packet. The client connection information may be written into the TCP option field of the ACK packet. The modified ACK packet may include an identifier indicating it is a modified ACK packet to form the self-defined packet.

In one embodiment, the modified ACK packet identifier may be placed in the reserved bits of the TCP header. For example, when there are four reserved bits, one of the bits may be used for the identifier and three other bits may remain empty.

When the real server receives the self-defined packet generated by modifying the ACK packet, it may determine that the received packet is a self-defined packet based on the identifier. The real server may extract the client connection information from the TCP option fields of the self-defined packet. Because the connection information of the real server has been sent to the client, the real server may establish a TCP connection with client based on the extracted client connection information.

In one embodiment, the serial number of the self-defined packet is the same as that of the ACK packet to ensure that there is no inconsistency in the serial number of the packet transmitted among the client, load-balancing device, and real server.

In some embodiments, when establishing the TCP connection with the client, the real server extracts the client connection information, applies for a socket data structure, initializes related member variables of the socket, sets the TCP status of the socket to “established,” and employs system socket creation functions to create the socket, so as to establish the connection. A socket is used to describe an address and port to indicate a node of a communication chain, and to realize communications between virtual machines and computers.

In another embodiment, the self-defined packet may be a self-defined SYN packet, which adopts three-way handshakes of the TCP scheme.

A serial number of the self-defined SYN packet may be the serial number computed based on the SYN packet transmitted from the client. The confirmation number of the self-defined SYN packet may be set to be the serial number of the SYN+ACK packet returned from the load-balancing device. The above assignment of serial number ensures that there is no inconsistency in the serial number of the packet transmitted among the client, load-balancing device and real server.

The client connection information may be written into TCP option fields of the self-defined SYN packet. In one embodiment, the address of the load-balancing device may also be written into TCP option fields. These may be implemented by adding self-defined TCP option fields to the self-defined SYN packet to write the address of the load-balancing device therein.

After the real server receives the self-defined SYN packet, it may extract the client connection information therefrom, and, based on the extracted client connection information, establish a half-open TCP connection with the client and later convert the half-open TCP connection to a full TCP connection.

For example, the real server may establish a half-open TCP connection with the client based on the extracted client connection information. The real server may determine whether a packet is a self-defined SYN packet by checking whether the packet includes the address of the load-balancing device included in, for example, TCP option fields.

Based on the TCP and the address of the load-balancing device, the real server may return a SYN+ACK packet to the load-balancing device so that the load-balancing device may forward the ACK packet received from the client to the real server. Upon receiving the ACK packet, the real server may convert the half-open TCP connection to the full TCP connection.

In the illustrated embodiment, the load-balancing device provides defense to attacks. The load-balancing device preserves the client connection information in the serial number of the SYN+ACK packet. When the load-balancing device receives the ACK packet returned from the client, it may send a self-defined SYN packet to the real server so that the real server may determine that it is a legitimate SYM packet to be processed.

When the real server receives the self-defined SYN packet, it may identify the self-defined TCP option fields in the self-defined SYN packet, establish a half-open TCP connection, and, based on the address of the load-balancing device included in the self-defined TCP option fields, return the SYN+ACK packet to the load-balancing device.

Connection information stored by the load-balancing device may not include the address of load-balancing device. To establish a connection, an address and port of the client and an address and port of the real server are generally needed. A returned SYN+ACK packet may need to include such information. The real server may return the SYN+ACK packet by transmitting it through, for example, an IPIP tunnel, to preserve the address and port information. The IPIP tunnel is a protocol that attaches IP (Internet Protocol) to a header of an IP packet.

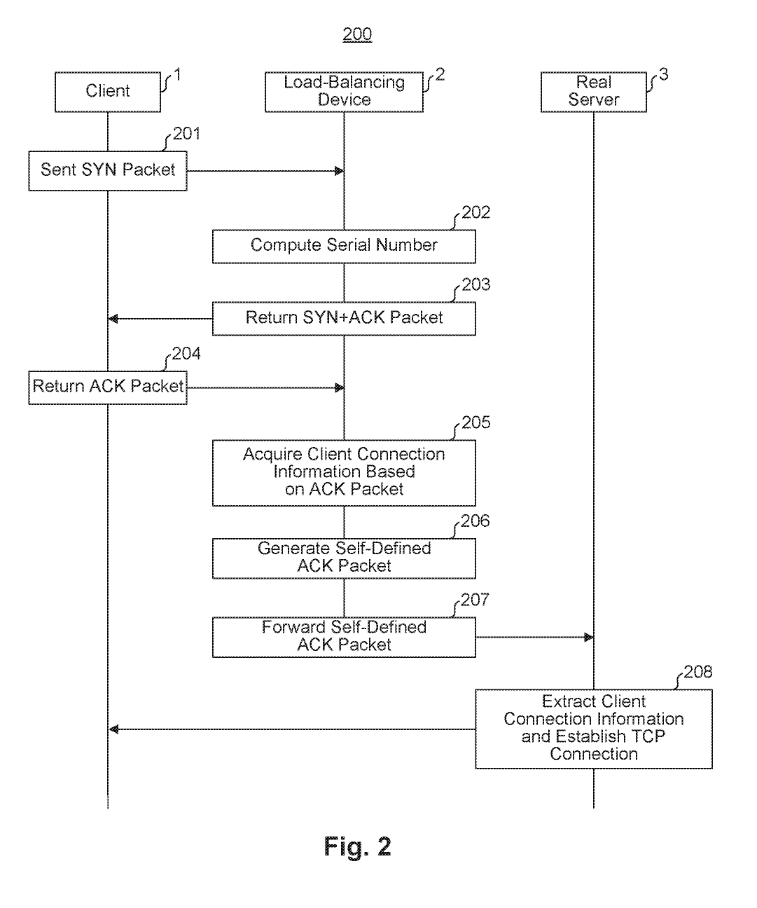

FIG. 2 is a flow chart illustrating an exemplary method 200 for establishing a TCP connection in a load-balancing system including a client 1, a load-balancing device 2, and a real server 3. The method 200 includes the following steps:

In step 201, the client 1 forwards an SYN packet to the load-balancing device 2. The SYN packet includes client connection information.

In step 202, the load-balancing device 2 computes a serial number based on the client connection information.

In one embodiment, the serial number may be obtained with a synchronous cookie (SYN cookie) technology. The client connection information included in the SYN packet may be processed with a cookie function to generate a cookie value, which may be used as the serial number. SYN cookie technology may be employed to prevent the SYN flood attacks. When returning an SYN+ACK packet in response to a TCP packet, the SYN cookie technology does not allocate a specific data segment. Instead, it may compute a cookie value based on the SYN packet.

Assuming that Saddr is a client source address, daddr is a visit destination address, sport is a client source port, and dport is a visit destination port, a cookie value may be obtained as follows:

1. A=cookie hash(saddr, daddr, sport, dport, 0, 0), where the hash function employs a crc32 algorism;

2. B=a serial number of SYN packet from the client;

3. C=jiffies/(HZ*60), where jiffies is current system clock counting, HZ is system clock counting in seconds, and the unit of C is minute;

4. D=cookie hash(saddr, daddr, sport, dport, C, 1);

5. E=preserved TCP option value, distribution: [21][20][19-16][15-0], where the 21 bits are the SACK option, the 20 bits are the timestamp option, 19-16 bits are wscale option, and 15-0 bits are the mss option; and

6. cookie=A+B+(C [symbol] 24)+((D+E) & 0x00FFFFFF).

In step 203, the load-balancing device 2 returns an SYN+ACK packet that includes connection information of the real server 3 to the client 1. The serial number that the load-balancing device 2 computed based on the client connection information is assigned to be the serial number of the SYN+ACK packet.

In step 204, the client 1 returns an ACK packet to the load-balancing device 2. A confirmation number of the ACK packet may be generated based on the serial number of the SYN+ACK packet. In one embodiment, the confirmation number of the ACK packet equals to the serial number of the SYN+ACK plus one.

In step 205, the load-balancing device 2 acquires the client connection information based on the confirmation number of the ACK packet. In one embodiment, the serial number may be obtained by subtracting one from the confirmation number. When the serial number is a cookie value, the cookie value may be checked by an algorism to obtain the client connection information. For example, a checking process is explained as follows.

1. Set the cookie value to be the confirmation number of the ACK packet minus one;

2. Calculate cookie=Cookie−A−B (the definition of A and B is explained above);

3. C1=jiffies/(HZ*60), where jiffies increases as a lapse of time;

4. Diff=C1−(Cookie [symbol] 24)=C1−C, where Diff is a time difference, where the cookie is invalid when Diff is greater than a predetermined threshold value;

5. C=C1−Diff, D=cookie hash(saddr, daddr, sport, dport, C, 1);

6. E=(cookie−D) & 0x00FFFFFF, to acquire the preserved TCP option;

7. Determine whether the obtained TCP option is legitimate; and

8. If the TCP option is legitimate, return the value of the TCP option.

If the TCP option is not legitimate, the method 200 may be terminated immediately, without advancing to further steps.

In step 206, the load-balancing device 2 may include an identifier in the ACK packet returned from the client 1, and may write the client connection information into the ACK packet to generate a self-defined packet.

The identifier may be employed to identify the self-defined packet. In one embodiment, the identifier may be written into one of the reserved bits of the ACK packet header. The client connection information may be written into the TCP option fields.

In step 207, the load-balancing device 2 forwards the self-defined ACK packet to the real server 3.

In step 208, the real server 3 extracts the client connection information from the self-defined packet, and establishes a TCP connection with the client 1 based on the client connection information.

In some embodiments, the ACK packet returned from the client 1 may include a request for data or the ACK packet may be a request packet that includes a confirmation identifier, so that the self-defined ACK packet may also include the data request.

After the real server 3 establishes the TCP connection with the client 1, it may provide a response packet to the client based on the data request.

In the illustrated embodiment, the client connection information may be preserved in the SYN+ACK packet returned by the load-balancing device 2 to the client 1. There may be no need to create a database to store the client connection information. In addition, the system resource would not be consumed to create a database. Even if the system is under a SYN flood attack, the load-balancing device 2 may provide defense to the attack so that it would not affect the normal service requests from the client 1 to the real server 3.

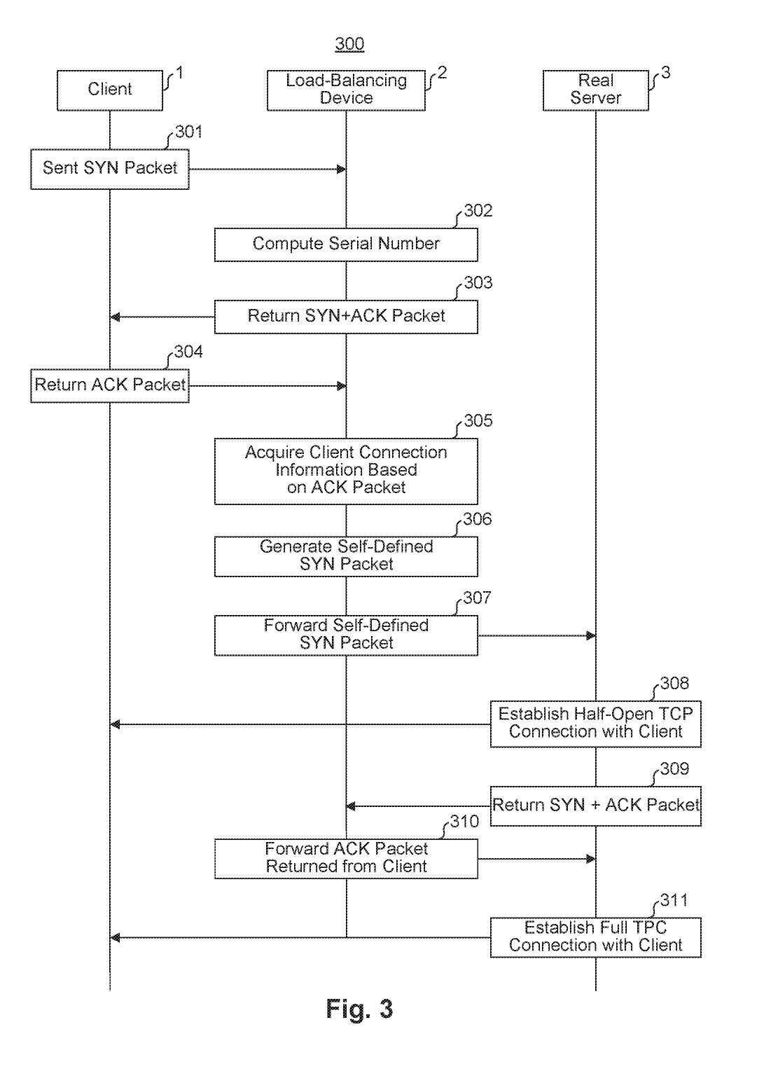

FIG. 3 is a flow chart illustrating another method 300 for establishing a TCP connection in a load-balancing system including a client 1, a load-balancing device 2, and a real server 3. The method 300 includes the following steps:

In step 301, the client 1 forwards an SYN packet to the load-balancing device 2. The SYN packet includes client connection information.

In step 302, the load-balancing device 2 computes a serial number based on the client connection information.

In one embodiment, the serial number may be obtained with a SYN cookie technology. The client connection information included in the SYN packet may be processed with a cookie function to generate a cookie value, which may be used as the serial number. SYN cookie technology may be employed to prevent SYN flood attacks. When returning the SYN+ACK packet in response to the TCP packet, the SYN cookie technology does not allocate a specific data segment. Instead, it may compute a cookie value based on the SYN packet.

In step 303, the load-balancing device 2 returns an SYN+ACK packet that includes connection information of the real server 3 to the client 1. The serial number computed in step 302 may be assigned to be the serial number of the SYN+ACK packet.

In step 304, the client 1 returns an ACK packet to the load-balancing device 2. A confirmation number of the ACK packet may be formed based on the serial number of the SYN+ACK packet. In one embodiment, the confirmation number of the ACK packet equals to the serial number of the SYN+ACK plus one.

In step 305, the load-balancing device 2 acquires the client connection information based on the confirmation number of the ACK packet. In one embodiment, the serial number may be obtained by subtracting one from the confirmation number. When the serial number is a cookie value, the cookie value may be checked by an algorism to obtain the client connection information. The process of checking the cookie value is explained above with respect to the method 200 and will not be repeated herein.

In step 306, the load-balancing device 2 generates a self-defined SYN packet based on the SYN packet transmitted from the client 1. The load-balancing device 2 uses the serial number of the SYN packet returned from the client 1 as a serial number of the self-defined SYN packet; uses the serial number of the SYN+ACK packet transmitted from the load-balancing device 2 as a confirmation number of the self-defined SYN packet; writes the client connection information into the self-defined SYN packet; and writes the address of the load-balancing device 2 into a self-defined field of the self-defined SYN packet.

In step 307, the load-balancing device 2 forwards the self-defined SYN packet to the real server 3.

In step 308, the real server 3 establishes a half-open TCP connection with the client 1 based on the client connection information included in the self-defined SYN packet.

In step 309, the real server 3 returns an SYN+ACK packet to the load-balancing device 2, based on the address of the load-balancing device 2. The serial number of the SYN+ACK packet returned from the real server 3 may be the confirmation number of the self-defined SYN packet.

In step 310, the load-balancing device 2 forwards the ACK packet returned from the client 1 to the real server 3 after it receives the SYN+ACK packet returned from the real server 3.

In step 311, the real server 3 establishes a full TCP connection with the client 1 after receiving the ACK packet of the client 1.

In some embodiments, the ACK packet returned from the client 1 may include a data request or the ACK packet may be a request packet that includes a confirmation identifier. After the real server 3 receives the ACK packet returned from the client 1 and establishes the TCP connection with the client 1, it may provide a response packet to the client based on the data request.

In the illustrated embodiment, the client connection information may be preserved in the SYN+ACK packet transmitted from the load-balancing device 2 to the client 1. Creating a database to store the client connection information may be omitted. In addition, the system resource would not be consumed to create a database. Even if the system is under a SYN flood attack, it may still provide normal services because the system resources would not be exhausted and no database is created to store client connection information. Because the load-balancing device 2 provides defense to attacks, the real server 3 receives legitimate SYN packet (the self-defined SYN packet) so that it may provide normal services.

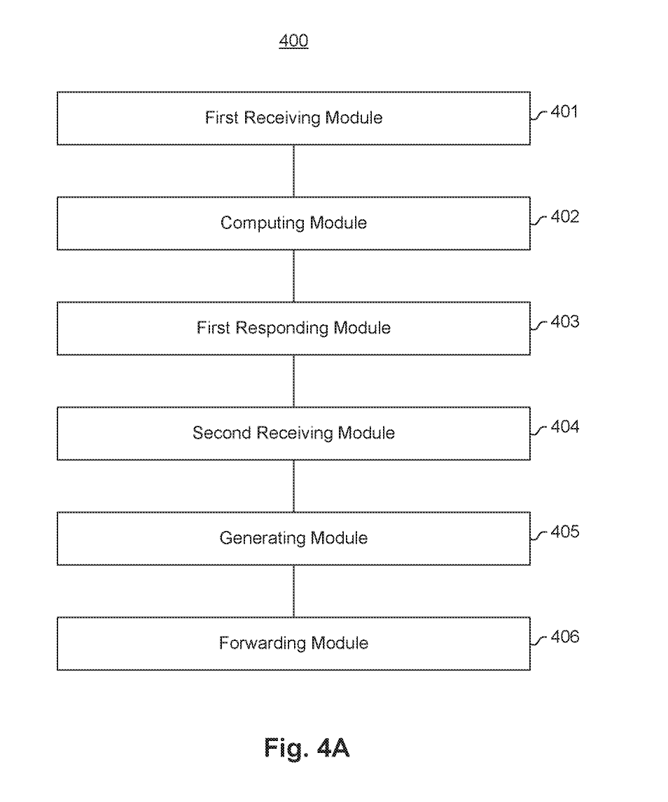

FIG. 4A is block diagram illustrating an exemplary load-balancing device 400 consistent with embodiments of present disclosure. The device 400 may include a first receiving module 401, a computing module 402, a first responding module 403, a second receiving module 404, a generating module 405, and a first forwarding module 406.

The first receiving module 401 may be configured to receive an SYN packet transmitted from a client.

The computing module 402 may be configured to compute a serial number based on the SYN packet received from the client.

The first responding module 403 may be configured to return an SYN+ACK packet to the client and assign the serial number to the SYN+ACK packet.

The second receiving module 404 may be configured to receive an ACK packet from the client and, based on a confirmation number of the ACK packet, acquire the client connection information.

The generating module 405 may be configured to generate a self-defined packet to include the client connection information.

The first forwarding module 406 may be configured to forward the self-defined packet to the real server so that the real server may extract the client connection information from the self-defined packet and establish a TCP connection with the client based on the client connection information.

In the illustrated embodiment, the load-balancing device uses client connection information included in the SYN packet to compute the serial number, and assigns the serial number to the SYN+ACK packet transmitted from the load-balancing device to the client, so that the real server may not need to create a database to store the client connection information. Because there is no need to create a database to store the client connection information, the device 400 reduces consumption of resource and provides defense to attacks that cause the real server to create a huge database and exhaust its resources.

In the illustrated embodiment, the defense to the attacks is realized by the load-balancing device, which further shields the real server from attacks.

After the load-balancing device 400 receives the ACK packet from the client, it forwards a self-defined packet including the client connection information to the real server so that the real server may establish a TCP connection with the client.

In some embodiments, the generating module 405 may be further configured to add an identifier and write client connection information into the ACK packet returned from the client to generate the self-defined packet. The identifier may be used to indicate that it is a modified ACK packet.

That is, the ACK packet returned from the client may be directly modified to generate the self-defined packet. According to the TCP scheme, the TCP option fields of the ACK packet may be empty so that the client connection information may be written therein. Further, The identifier may be added in the modified ACK packet to generate the self-defined packet.

In one embodiment, the modified ACK packet identifier may be placed in the reserved bits of the TCP header. For example, when there are four reserved bits, one of the bits may be used for the identifier and three other bits remain empty for use.

When the real server receives the self-defined packet generated by modifying the ACK packet, it may determine that the received packet is a self-defined packet based on the identifier. The real server may extract the client connection information from the TCP option fields. Because the connection information of the real server has been sent to the client, the real server may establish a TCP connection with client based on the extracted client connection information.

In one embodiment, the serial number of the self-defined packet may be the same as that of the ACK packet to ensure that there is no inconsistency in the serial number of the packet transmitted among the client, load-balancing device and real server.

In some embodiments, when establishing the TCP connection with the client, the real server extracts the client connection information, applies for a socket data structure, initializes related member variables of the socket, sets TCP status of the socket to “established,” and employs system socket creation functions to create the socket, so as to establish the TCP connection with the client.

In another embodiment, the generating module 405 is further configured to set a serial number of the self-defined SYN packet to be the serial number of the SYN packet transmitted from the client; set the serial number of the SYN+ACK packet transmitted from the load-balancing device to be the confirmation number of the self-defined SYN packet; write the client connection information into the self-defined SYN packet; and add the address of the load-balancing device into a self-defined field of the self-defined SYN packet.

In some embodiments, referring to FIG. 4B, the first forwarding module 406 may include a first forwarding submodule 406-1 and a second forwarding submodule 406-2.

The first forwarding submodule 406-1 may be configured to forward the self-defined SYN packet to the real server so that the real server may establish a half-open TCP connection with the client, based on the client connection information included in the self-defined SYN packet.

The second forwarding submodule 406-2 may be configured to, after the SYN+ACK packet transmitted from the real server based on the address of the load-balancing device is received, forward the ACK packet returned from the client to the real server, so that the real server may convert the half-open TCP connection to a full TCP connection with the client.

For example, the real server may establish the half-open TCP connection with the client based on the extracted client connection information. The real server may determine whether a packet is a self-defined SYN packet by checking whether the packet includes the address of the load-balancing device included in, for example, TCP option fields.

Based on the TCP and the address of the load-balancing device, the real server may return an SYN+ACK packet to the load-balancing device so that the load-balancing device may forward the ACK packet received from the client to the real server. Upon receiving the ACK packet, the real server may convert the half-open TCP connection to the full TCP connection.

In the illustrated embodiment, the load-balancing device provides defense to attacks. When the load-balancing device receives the ACK packet returned from the client, it may send the self-defined SYN packet to the real server so that the real server may determine that it is a legitimate SYN packet to be processed.

In some embodiments, the ACK packet returned from the client may include a request for data so that the self-defined ACK packet may also include the data request. After the real server establishes the TCP connection with the client, it may provide a response packet to the client based on the data request.

In some embodiments, the second receiving module 404 may be further configured to receive the ACK packet that includes a data request returned from the client, and, based on the confirmation number of the ACK packet, compute the client connection information.

The generating module 405 is further configured to generate a self-defined packet to include the client connection information and the data request therein.

The first forwarding module 406 may be configured to forward the self-defined packet to the real server so that the real server may extract the client connection information and the data request from the self-defined packet, and, based on the client connection information, establish the TCP connection with the client, and send a response packet to the client based on the data request.

In one embodiment, a serial number may be obtained with the SYN cookie technology. The client connection information included in the SYN packet is processed with a cookie function to generate a cookie value, which is used as the serial number. The computing module 402 is further configured to employ the cookie function of the SYN cookie technology to process the client connection information to obtain a cookie value as the serial number for the SYN+ACK packet returned from the load-balancing device to the client.

In some embodiments, referring to FIG. 4C, the second receiving module may include a receiving submodule 404-1 and a checking submodule 404-2.

The receiving submodule 404-1 may be configured to receive the ACK packet returned from the client, and compute a cookie value based on the confirmation number of the ACK packet.

The checking submodule 404-2 may be configured to check the cookie value and acquire the client connection information after confirming the validity of the cookie value.

In one embodiment, the cookie value equals to a value of subtracting one from the confirmation number. If the cookie value passes the checking by the checking submodule 404-2, the client connection information may be acquired therefrom.

The computing and checking of the cookie value is explained above and will not be repeated again herein.

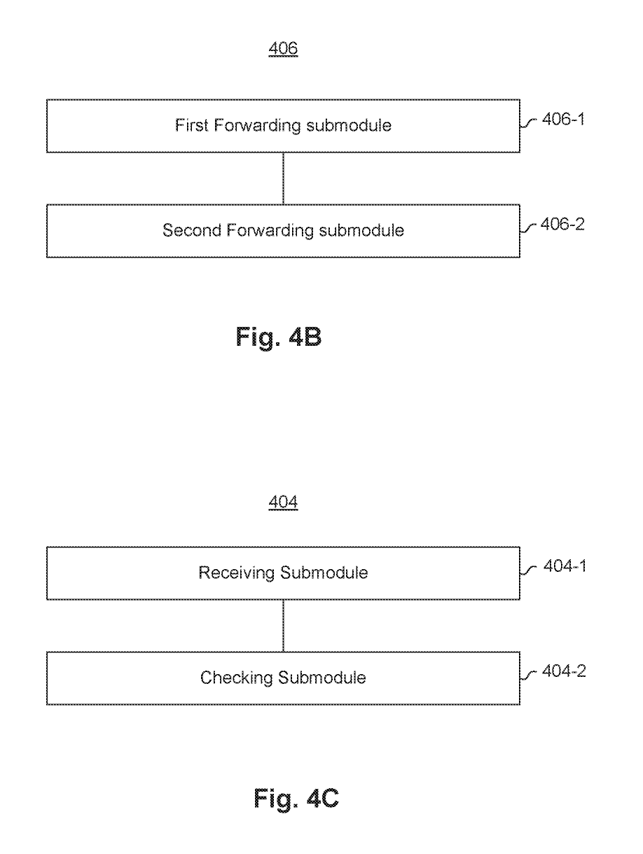

FIG. 5 is a block diagram of a client device 500 of a load-balancing system consistent with embodiments of the present disclosure. Referring to FIG. 5, the client device 500 includes a second forwarding module 501, a third receiving module 502, and a second responding module 503.

The second forwarding module 501 may be configured to forward an SYN packet including client connection information to a load-balancing device.

The third receiving module 502 may be configured to receive an SYN+ACK packet returned from the load-balancing device. A serial number of the SYN+ACK packet may be computed by the load-balancing device based on the client connection information included in the SYN packet. The SYN+ACK packet includes connection information of a real server.

The second responding module 503 may be configured to respond to the load-balancing device with an ACK packet so that the load-balancing device may perform computation to obtain the client connection information based on a confirmation number of the ACK packet, write the client connection information into a self-define packet, and forward the self-define packet to the real server. The real server may extract the client connection information from the self-defined packet and establish a TCP connection with the client based on the client connection information.

In some embodiments, the ACK packet transmitted from the second responding module 503 may include a request for data so that the load-balancing device may include the data request in the self-defined packet. After the real server establishes the TCP connection with the client, it may forward a response packet to the client based on the data request.

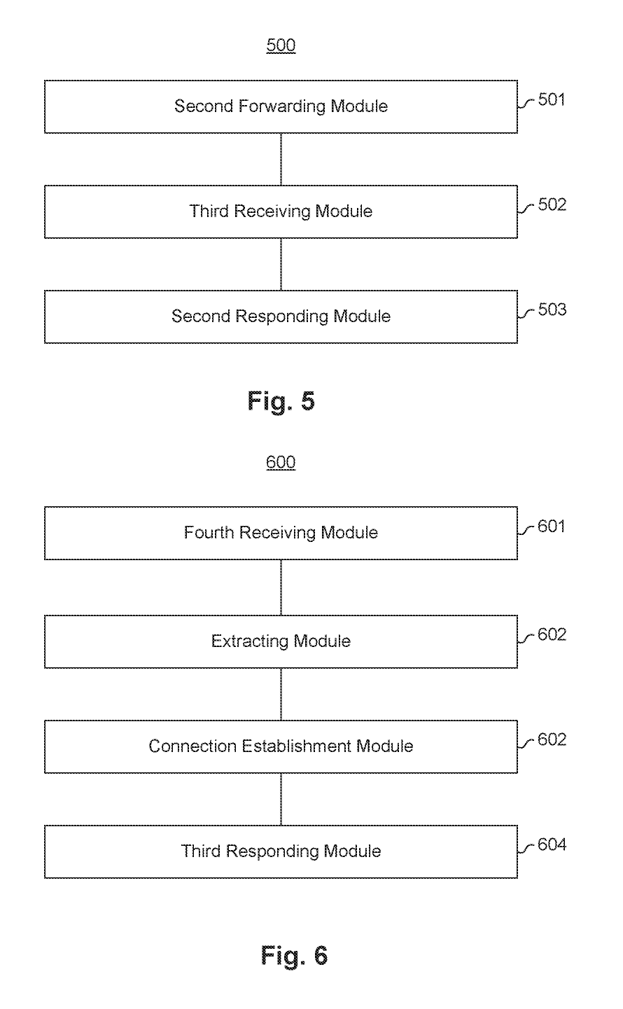

FIG. 6 is a block diagram of a real server 600 of a load-balancing system consistent with embodiments of the present disclosure. Referring to FIG. 6, the real server 600 may include a fourth receiving module 601, an extracting module 602, and a connection establishment module 603.

The fourth receiving module 601 may be configured to receive a self-defined packet transmitted from a load-balancing device. In one embodiment, the self-defined packet is generated by the following process: the load-balancing device may receive an SYN packet transmitted from a client and compute a serial number based on client connection information included in the SYN packet. The load-balancing device may assign the serial number to an SYN+ACK packet that includes connection information of real server and send the SYN+ACK packet to the client. The load-balancing device may then receive an ACK packet from the client and may perform computation to obtain the client connection information based on a confirmation number of the ACK packet. The load-balancing device may write the client connection information to the self-defined packet.

The extracting module 602 may be configured to extract the client connection information from the self-defined packet.

The connection establishment module 603 may be configured to establish a TCP connection with the client based on the client connection information.

In some embodiments, the self-defined packet is a modified ACK packet returned from the client. The ACK packet is added with the client connection information and an identifier to indicate that it is a self-defined ACK packet. The extracting module 602 determines that the ACK packet is a self-defined packet by recognizing the identifier, and extract the client connection information from the modified ACK packet. The connection establishment module 603 establishes the TCP connection with the client based on the client connection information.

In some embodiments, the self-defined packet is a self-defined SYN packet. A serial number of the self-defined SYN packet is the serial number of the SYN packet transmitted from the client. A confirmation number of the self-defined SYN packet may be the serial number of a SYN+ACK packet transmitted from the load-balancing device to the client. The self-defined SYN packet may be a modification of the SYN packet transmitted from the client, modified to include the client connection information in its TCP option fields and an address of the load-balancing device in a self-defined field. The self-defined field may be a self-defined TCP option field.

Based on the TCP scheme and the client connection information, the connection establishment module 603 may establish a half-open TCP connection with the client and later convert the half-open TCP connection to a full TCP connection.

The extracting module 602 may be configured to, after receiving the self-defined SYN packet that includes a self-defined field, extract the client connection information, to prompt the connection establishment module 603 to establish the half-open TCP connection with the client.

In some embodiments, the real server 600 further includes a third responding module 604 configured to return an SYN+ACK packet to the load-balancing device, based on the address of the load-balancing device.

In some embodiments, the fourth receiving module 601 is further configured to receive the ACK packet returned from the client to the load-balancing device and forwarded by the load-balancing device, after the load-balancing device receives the SYN+ACK packet sent by the third responding module 604. After the fourth receiving module 601 receives the ACK packet of the client, the connection establishment module 603 may convert the half-open TCP connection to the full TCP connection.

In some embodiments, the ACK packet of the client may include a request for data. The real server 600 may return a response packet based on the data request after establishing TCP connection with the client.

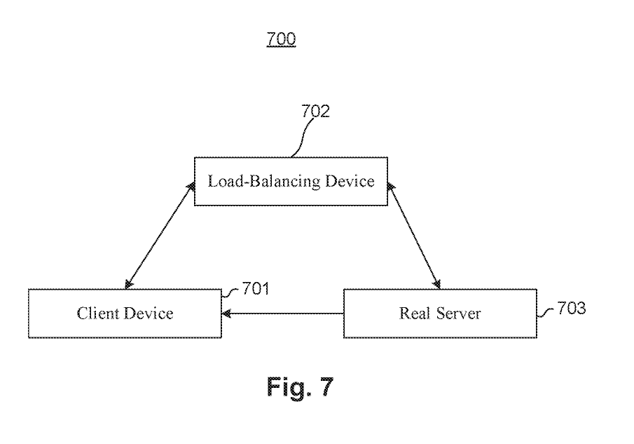

FIG. 7 is a block diagram illustrating a load-balancing system 700 consistent with embodiments of the present disclosure. The load-balancing system 700 includes a client device 701, a load-balancing device 702, and a real server 703.

The client device 701 may be configured to forward an SYN packet to the load-balancing device 702, receive an SYN+ACK packet returned from the load-balancing device 702, and forward an ACK packet to the load-balancing device 702.

The load-balancing device 702 may be configured to compute a serial number based on client connection information included in the SYN packet transmitted from the client device 701, return the SYN+ACK packet to the client device 701, assign the serial number to the SYN+ACK packet, compute to obtain the client connection information based on a confirmation number of the ACK packet returned from the client device 701, generate a self-defined packet, and forward the self-defined packet to the real server 703.

The real server 703 may be configured to extract the client connection information from the self-defined packet transmitted from the load-balancing device 702, and establish a TCP connection with the client device 701 based on the client connection information.

In the illustrated embodiment, the load-balancing device 702 preserves the client connection information included in the SYN packet in the SYN+ACK packet, so that there is no need to create a databased to store the client connection information to reduce consumption of system resources. The load-balancing device 702 provides defense to attacks and improves security. Based on the self-defined packet, the load-balancing device 702 may transmit the client connection information to the real server 703. After the real server 703 received the self-defined packet, it may establish the TCP connection with the client device 701.

The methods and devices consistent with embodiments of the present disclosure enable establishment of a TCP connection among a client and a real server and may effectively defend SYN flood attacks. There is no need to create a database to store the client connection information, which reduces consumption of system resources. The methods and devices consistent with embodiments of the present disclosure enable that the normal service requests may be serviced.

The devices and servers consistent with the embodiments of the present disclosure may include one or more processors, input/output ports, network connectors, and memory devices.

The memory devices includes non-transitory computer-readable medium for storing instructions, which, when executed by the one or more processors, cause the processors to perform the methods described above. The medium may be random access memory (RAM), or other non-volatile memory, such as read only memory (ROM), or flash memory. The memory device may be inside of a computer.

The non-transitory computer-readable medium may permanently or temporarily store information. It may be a mobile or stationary medium. The information may be computer-readable instructions, data structures, process modules, or other data. The non-transitory computer-readable medium may include phase-change random access memory (PRAM), static random-access memory (SRAM), dynamic random-access memory (DRAM), other types of RAM, Electrically Erasable Programmable Read-Only Memory (EEPROM), flash memory, registers, caches, CD, DVD, other types of optical storage medium, magnetic tapes, magnetic drives, or other types of magnetic storage medium, to storage computer messages.

The illustrated methods, devices, servers, and systems may be performed by software, hardware, or a combination of software and hardware for allowing a specialized device having the specialized components to perform the functions described above. For example, they may be implemented in an application-specific integrated circuit (ASIC), or other hardware devices. In one embodiment, the steps and functions of a module or submodule may be performed by a physical processor. In one embodiment, the steps and their relevant data structures may be stored in a non-transitory computer-readable medium, such as a RAM, a magnetic or optical drive, a magnetic disc and the like. In some embodiments, the steps or functions of the present disclosure may be implemented with hardware devices, such as circuits designed to work with the processor to execute the steps or functions.

In some embodiments, all or a portion of the methods may be implemented by computer programs, such as computer instructions, which, when executed by a computer, cause the computer to perform the methods or functions. These computer instructions may be stored in a portable or non-portable, non-transitory computer storage medium, may be transmitted by broadcasting or in a network, and/or may be stored in a memory device of a computing device. A device consistent with the embodiments of the present disclosure includes a memory device configured to store the computer instructions and a processor configured to execute the instructions to perform the methods or embodiments of the present disclosure.

Other embodiments of the invention will be apparent to those skill in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims. One of ordinary skill in the art will also understand that multiple ones of the above described steps or modules may be combined as one step or module, and each of the above described modules may be further divided into a plurality of submodules. A singular expression of a term in the present disclosure does not exclude that it may be plural. The ordinal numbers used in the present disclosure does not necessarily present the order of the steps or methods. The order of the steps or methods may be modified according to the practical needs.

It will be appreciated that the present invention is not limited to the exact construction that has been described above and illustrated in the accompanying drawings, and that various modifications and changes may be made without departing from the scope thereof. It is intended that the scope of the invention only be limited by the appended claims.

1.-14. (canceled)

15. An apparatus for establishing a connection in a load-balancing system, the apparatus being coupled between a client device and a real server that provides service to the client device, the apparatus comprising:
a memory device storing an instruction; and
a processor arranged to execute the instruction stored in the memory device to:
receive a synchronous (SYN) packet from the client device, the SYN packet including client connection information;
based on the client connection information, compute a serial number;
return a first synchronous acknowledgement (SYN+ACK) packet to the client device, the serial number being assigned to be a serial number of the first SYN+ACK packet, the first SYN+ACK packet including connection information of the real server;
receive an acknowledgement (ACK) packet from the client and compute to obtain the client connection information based on a confirmation number of the ACK packet;
generate a self-defined packet to include the client connection information; and
forward the self-defined packet to the real server so that the real server extracts the client connection information from the self-defined packet and establishes a Transmission Control Protocol (TCP) connection with the client device based on the client connection information.

16. The apparatus of claim 15, wherein the processor is further arranged to:
add an identifier and write the client connection information into the ACK packet returned from the client to generate the self-defined packet, the identifier being to identify the self-defined packet.

17. The apparatus of claim 15, wherein the processor is further arranged to:
set a serial number of the self-defined SYN packet to be a serial number of the SYN packet transmitted from the client;
set a serial number of the first SYN+ACK packet transmitted from the load-balancing device to be a confirmation number of the self-defined SYN packet;
write the client connection information into the self-defined SYN packet; and
add an address of the load-balancing device to the self-defined SYN packet.

18. The apparatus of claim 17, wherein the processor is further arranged to:
forward the self-defined SYN packet to the real server so that the real server establishes a half-open TCP connection with the client based on the client connection information included in the self-defined SYN packet, and
after receiving a second SYN+ACK packet transmitted from the real server based on the address of the load-balancing device, forward the ACK packet returned from the client device to the real server so that the real server converts the half-open TCP connection to the TCP connection, wherein a serial number of the second SYN+ACK packet is the confirmation number of the self-defined SYN packet.

19. The apparatus of claim 15,
wherein the ACK packet returned from the client device includes a request for data,
wherein the processor is further arranged to:
generate the self-defined packet to include the client connection information and the data request; and
forward the self-defined packet to the real server so that the real server extracts the client connection information and the data request from the self-defined packet so that the real server establishes the TCP connection with the client device and forwards a response packet to the client device based on the data request after the establishment of the TCP connection.

20. The apparatus of claim 15, the processor is further arranged to:
compute the serial number using a cookie function of a synchronous cookie technology to compute the client connection information to obtained a cookie value as the serial number;
receive the ACK packet from the client device and compute the confirmation number of the ACK packet to obtain the cookie value; and
check a validity of the cookie value, and acquire the client connection information when the cookie value passes the checking.

21. A computer-implemented method for establishing a connection in a load-balancing system, the method being performed by a load-balancing device coupled between a client device and a real server that provides service to the client device, the method comprising:
receiving a synchronous (SYN) packet from the client device, the SYN packet including client connection information;
based on the client connection information, computing a serial number;
returning a first synchronous acknowledgement (SYN+ACK) packet to the client device, the serial number being assigned to be a serial number of the first SYN+ACK packet, the first SYN+ACK packet including connection information of the real server;
receiving an acknowledgement (ACK) packet from the client and computing to obtain the client connection information based on a confirmation number of the ACK packet;
generating a self-defined packet to include the client connection information; and
forwarding the self-defined packet to the real server so that the real server extracts the client connection information from the self-defined packet and establishes a Transmission Control Protocol (TCP) connection with the client device based on the client connection information.

22. The computer-implemented method of claim 21, wherein the generating of the self-defined packet includes:
adding an identifier and writing the client connection information into the ACK packet returned from the client to generate the self-defined packet, the identifier being to identify the self-defined packet.

23. The computer-implemented method of claim 21, wherein the self-defined packet is a self-defined SYN packet, wherein the self-defined SYN packet is generated by:
setting a serial number of the self-defined SYN packet to be a serial number of the SYN packet transmitted from the client;
setting a serial number of the first SYN+ACK packet transmitted from the load-balancing device to be a confirmation number of the self-defined SYN packet;
writing the client connection information into the self-defined SYN packet; and
adding an address of the load-balancing device to the self-defined SYN packet.

24. The computer-implemented method of claim 23,
wherein the self-defined SYN packet is forwarded to the real server so that the real server establishes a half-open TCP connection with the client based on the client connection information included in the self-defined SYN packet, and forwards a second SYN+ACK packet to the load-balancing device based on the address of the load-balancing device, wherein a serial number of the second SYN+ACK packet is the confirmation number of the self-defined SYN packet, and
wherein the method further comprises, after receiving the second SYN+ACK packet, forwarding the ACK packet returned from the client device to the real server so that the real server converts the half-open TCP connection to the TCP connection.

25. The computer-implemented method of claim 21,
wherein the ACK packet returned from the client device includes a request for data,
wherein the generating of the self-defined packet includes writing the client connection information and the data request to the self-defined packet, and
wherein forwarding of the self-defined packet to the real server prompts the real server to extract the client connection information and the data request so that the real server establishes the TCP connection with the client device and forwards a response packet to the client device based on the data request after the establishment of the TCP connection.

26. The computer-implemented method of claim 21,
wherein the computing of the serial number includes: using a cookie function of a synchronous cookie technology to compute the client connection information to obtained a cookie value as the serial number; and
wherein the computing to obtain the client connection information based on the confirmation number includes: computing the confirmation number to obtain the cookie value, checking a validity of the cookie value, and acquiring the client connection information when the cookie value passes the checking.

27. A non-transitory computer readable medium that stores a set of instructions that is executable by at least one processor of a device to cause the device to perform a method, the method comprising:
receiving a synchronous (SYN) packet from the client device, the SYN packet including client connection information;
based on the client connection information, computing a serial number;
returning a first synchronous acknowledgement (SYN+ACK) packet to the client device, the serial number being assigned to be a serial number of the first SYN+ACK packet, the first SYN+ACK packet including connection information of the real server;
receiving an acknowledgement (ACK) packet from the client and computing to obtain the client connection information based on a confirmation number of the ACK packet;
generating a self-defined packet to include the client connection information; and
forwarding the self-defined packet to the real server so that the real server extracts the client connection information from the self-defined packet and establishes a Transmission Control Protocol (TCP) connection with the client device based on the client connection information.

28. The non-transitory computer readable medium of claim 27, wherein the set of instructions that is executable by the at least one processor of a device to cause the device to further perform:
adding an identifier and writing the client connection information into the ACK packet returned from the client to generate the self-defined packet, the identifier being to identify the self-defined packet.

29. The non-transitory computer readable medium of claim 27, wherein the self-defined packet is a self-defined SYN packet, wherein the set of instructions that is executable by the at least one processor of a data-processing device to cause the device to further perform:
setting a serial number of the self-defined SYN packet to be a serial number of the SYN packet transmitted from the client;
setting a serial number of the first SYN+ACK packet transmitted from the load-balancing device to be a confirmation number of the self-defined SYN packet;
writing the client connection information into the self-defined SYN packet; and
adding an address of the load-balancing device to the self-defined SYN packet.

30. The non-transitory computer readable medium of claim 29,
wherein the self-defined SYN packet is forwarded to the real server so that the real server establishes a half-open TCP connection with the client based on the client connection information included in the self-defined SYN packet, and forwards a second SYN+ACK packet to the load-balancing device based on the address of the load-balancing device, wherein a serial number of the second SYN+ACK packet is the confirmation number of the self-defined SYN packet, and
wherein the set of instructions that is executable by the at least one processor of a data-processing device to cause the device to further perform: after receiving the second SYN+ACK packet, forwarding the ACK packet returned from the client device to the real server so that the real server converts the half-open TCP connection to the TCP connection.

31. The non-transitory computer readable medium of claim 27,
wherein the ACK packet returned from the client device includes a request for data,
wherein the generating of the self-defined packet includes writing the client connection information and the data request to the self-defined packet, and
wherein forwarding of the self-defined packet to the real server prompts the real server to extract the client connection information and the data request so that the real server establishes the TCP connection with the client device and forwards a response packet to the client device based on the data request after the establishment of the TCP connection.

32. The non-transitory computer readable medium of claim 27,
wherein the computing of the serial number includes: using a cookie function of a synchronous cookie technology to compute the client connection information to obtained a cookie value as the serial number; and
wherein the computing to obtain the client connection information based on the confirmation number includes: computing the confirmation number to obtain the cookie value, checking a validity of the cookie value, and acquiring the client connection information when the cookie value passes the checking.
